(19) United States
(12) Patent Application Publication
(10) Pub. No.: US 2026/0237302 A1
(43) Pub. Date: Aug. 13, 2026

(54) Method and electronic device for assisting in the piloting of an aircraft via the monitoring of at least one operational criterion, and associated computer program and aircraft

(71) Applicant: THALES, Meudon (FR)

(72) Inventors: Aurélien THIRIET, MERIGNAC (FR); Daniel HAURET, MERIGNAC (FR); Jaime DIAZ-PINEDA, MERIGNAC (FR)

(21) Appl. No.: 19/474,712

(22) PCT Filed: Apr. 17, 2024
(86) PCT No.: PCT/EP2024/060358

§ 371 Date: Oct. 12, 2025

(30) Foreign Application Priority Data
Apr. 17, 2023 (FR) FR2303810

(51) Int. Cl. G08G 5/23; G06N 3/126; G06N 20/20; G08G 5/21

(52) U.S. Cl. CPC G08G 5/23; G06N 3/126; G06N 20/20; G08G 5/21

(57) ABSTRACT

A method including, for each of at least one operational criterion, determining a value of each characteristic variable of a set of characteristic variable(s) associated with the operational criterion, each characteristic variable being determined from at least one avionics variable, estimating a value of the operational criterion based on each determined value of a characteristic variable associated with the criterion and via implementation of an artificial intelligence algorithm, calculating a deviation between the estimated value and a desired value of the operational criterion, and of a characteristic variable, known as the causal variable, which is the main cause of the deviation, and if the calculated deviation is greater than a predefined threshold, performing at least one action selected from displaying the estimated value of the operational criterion, the calculated deviation and an indication of the causal variable, issuing an alert, and generating an instruction to control an avionics system.

### CROSS-REFERENCE TO RELATED APPLICATIONS

This application claims benefit under 35 USC § 371 of PCT Application No. PCT/EP2024/060358 entitled METHOD AND ELECTRONIC DEVICE FOR ASSISTING IN THE PILOTING OF AN AIRCRAFT VIA THE MONITORING OF AT LEAST ONE OPERATIONAL CRITERION, AND ASSOCIATED COMPUTER PROGRAM AND AIRCRAFT, filed on Apr. 17, 2024 by inventors Aurelian Thiriet, Daniel Hauret and Jaime Diaz-Pineda. PCT Application No. PCT/EP2024/060358 claims priority of French Patent Application No. 23 03810, filed on Apr. 17, 2023.

### FIELD OF THE INVENTION

The present invention relates to a method for assisting in the piloting of an aircraft, via the monitoring of at least one operational criterion of a mission of the aircraft during the execution of said mission, the method being implemented by an electronic piloting assistance device.

This invention further relates to a non-transitory computer-readable medium including a computer program comprising software instructions which, when executed by a computer, implements such a piloting assistance method.

The invention also relates to an electronic device for assisting piloting via the monitoring of at least one such operational criterion, and to an aircraft comprising such a piloting assistance device.

The invention relates more particularly to an aircraft, although it can be applied to any type of aircraft, such as a helicopter or a drone.

The invention relates to the field of aircraft piloting assistance, in particular in order to reduce the cognitive load for the aircraft pilot when carrying out an aircraft mission.

### BACKGROUND OF THE INVENTION

Document FR 3 111 210 B1 describes a system and a method for improved human-machine dialogue, comprising bidirectional translations between a user, such as the pilot, and the aircraft, in particular by translating, via a top-down translator, commands issued by the human in a form that can be manipulated by the machine, and conversely by translating, via a bottom-up translator, results produced by the machine in a form that is intelligible to the human. This document also describes the displaying of parts of intermediate reasoning carried out by the machine, to provide the user with an explanation of causes.

However, with such a system and such a method, the cognitive load for the pilot of the aircraft sometimes remains relatively high.

### SUMMARY OF THE DESCRIPTION

The aim of the invention is therefore to propose a method, and an associated electronic device, for assisting in the piloting of an aircraft which make it possible to further reduce the cognitive load for the pilot of the aircraft.

To this end, the invention relates to a method for assisting in the piloting of an aircraft, via the monitoring of at least one operational criterion of a mission of the aircraft during the execution of said mission,
the method being implemented by an electronic assistance device and comprising, for each operational criterion, the following steps:
   determining a value of each characteristic variable of a set of characteristic variable(s) associated with said operational criterion, the set of characteristic variable(s) being specific to each operational criterion and predefined for each operational criterion, each characteristic variable being determined from at least one avionics variable, each avionics variable being acquired from a source selected from an avionics system, a sensor and a database;
   estimating a value of the operational criterion on the basis of each determined value of a characteristic variable associated with said operational criterion and via the implementation of an artificial intelligence algorithm;
   calculating a deviation between the estimated value of the operational criterion and a desired value of said operational criterion, and of a characteristic variable, known as the causal variable, which is the main cause of said deviation, said causal variable being calculated using the artificial intelligence algorithm;
   if the calculated deviation is greater than a predefined threshold, performing at least one action selected from the group consisting of: displaying, on a display system, the estimated value of the operational criterion, the calculated deviation and an indication of the causal variable; issuing an alert as a function of the calculated deviation; and generating an instruction to control an avionics system as a function of the estimated value of the operational criterion.

The piloting assistance method according to the invention can then help the pilot to assess the chances of success of the aircraft's mission or the need to replan it, by estimating the value of each operational criterion, then by displaying the estimated value of each operational criterion, and/or by issuing an alert according to the estimated value of each operational criterion.

The piloting assistance method according to the invention therefore provides significant assistance to the pilot and reduces the cognitive load required to diagnose the chances of success of the mission. By regularly calculating the deviation between the estimated value of the operational criterion and a desired value of said operational criterion, the piloting assistance method according to the invention provides, in other words, a guardian angel function for piloting the aircraft, in particular by drawing the attention of the user, such as a member of the aircraft crew, in the form of a visual and/or audible alert if the calculated deviation is greater than the predefined threshold.

The piloting assistance method according to the invention also makes it possible to provide the user with an indication as to the characteristic variable which is the main cause of said deviation, also known as the causal variable, i.e. the one which, among the set of characteristic variable(s) associated with said operational criterion, is mainly the cause of this deviation, or, in other words, is the main source of this deviation. This makes it easier to explain to the user the cause of the reported deviation thereby reducing the cognitive load required to know how to react in order to limit that deviation. In other words, the artificial intelligence algorithm used to identify the causal factor makes the diagnosis more intelligible to the user.

Preferably, for each operational criterion, the set of characteristic variable(s) associated with said operational criterion can be consulted and modified by a user, and this piloting assistance can then be adapted by and for the user.

Even more preferably, the artificial intelligence algorithm used to estimate the value of the operational criterion comprises a fuzzy logic decision tree, which makes the diagnosis even more intelligible to the user.

Even more preferably, the piloting assistance method according to the invention makes it possible to help the pilot to look for symptoms of a situation by monitoring a plurality of operational criteria from among safety, punctuality, comfort, and ecology; and to take account of the consequences of a change in the context, such as a change in an environment of the aircraft, a change in an intention of the pilot for at least one operational criterion, and an action of the pilot that differs from a planned action. The piloting assistance method according to the invention then enables the user to better assess the impact of this change in context relative to an initially defined performance, i.e. in relation to the desired value of each operational criterion.

In other beneficial aspects of the invention, the piloting assistance method comprises one or more of the following features, taken in isolation or in any technically possible combination:
the method further comprises detecting at least one change from the group consisting of: modification of an environment of the aircraft, change in the desired value of a respective operational criterion, and action by the pilot that differs from a planned action; the steps of determining, estimating, and calculating then being implemented anew following this detection and depending on the at least one detected change;
the steps of determining, estimating, and calculating are repeated regularly,
the steps of determining, estimating, and calculating preferably being repeated periodically,
the period between two successive iterations of the steps of determining, estimating, and calculating even more preferably being less than 10 seconds;
   for each operational criterion, the set of characteristic variable(s) associated with said operational criterion and/or the desired value of said operational criterion can be consulted and modified by a user;
   a plurality of operational criteria are monitored;
the operational criteria preferably being monitored simultaneously;
   each operational criterion is chosen from the group consisting of: safety, punctuality, comfort, and ecology;
if a plurality of operational criteria are monitored, the operational criteria are preferably all the group's operational criteria consisting of: safety, punctuality, comfort and ecology;
   the set of characteristic variable(s) associated with safety comprises: a lift of the aircraft, a ratio between the amount of fuel available and the amount of fuel required, and an indicator quantifying the aircraft's adherence to a flight plan;
   the set of characteristic variable(s) associated with punctuality comprises: an indicator quantifying an arrival delay of the aircraft, a ratio between a number of passengers who missed a connection on arrival and a total number of passengers of the delayed flight, an indicator quantifying a delay of a subsequent flight of the aircraft due to the delay of the current flight of the aircraft;
   the set of characteristic variable(s) associated with comfort comprises: a take-off delay indicator, a number of vertical accelerations above a predefined threshold during the flight and a cumulative duration of vertical accelerations above a predefined threshold during the flight;
   the set of characteristic variable(s) associated with ecology comprises: a quantity of carbon dioxide emitted during flight, an indicator of the use of favourable air currents to modify the path of the aircraft relative to a path initially planned, a level of noise generated on the ground during landing, a ratio between a quantity of carbon dioxide emitted during the flight and a number of passengers carried;
   the artificial intelligence algorithm comprises a fuzzy logic decision tree,
the fuzzy logic decision tree preferably including at least one fuzzy inference system, each fuzzy inference system being configured to receive as input at least one determined value of a characteristic variable and to deliver as output a unitary evaluation value; for each fuzzy inference system, a correspondence between input(s) and output(s) being established by fuzzy logic; the value of the operational criterion then being estimated from the unitary evaluation value(s) calculated for the set of characteristic variable(s) associated with said operational criterion;
   the method further comprises a preliminary step of training the artificial intelligence algorithm on the basis of training data;
the preliminary learning of the artificial intelligence algorithm preferably being supervised learning;
if the artificial intelligence algorithm comprises a fuzzy logic decision tree, the preliminary learning of the fuzzy logic decision tree preferably still being carried out via the implementation of a genetic algorithm.

The invention also relates to a non-transitory computer-readable medium including a computer program comprising software instructions, which, when carried out by a computer, implement a piloting assistance method as defined above.

The invention further relates to an electronic device for assisting in the piloting of an aircraft, via the monitoring of at least one operational criterion of a mission of the aircraft during the execution of said mission, the device comprising:
a determination module configured to determine, for each operational criterion, a value of each characteristic variable of a set of characteristic variable(s) associated with said operational criterion, the set of characteristic variable(s) being specific to each operational criterion and predefined for each operational criterion, each characteristic variable being determined from at least one avionics variable, each avionics variable being acquired from a source selected from an avionics system, a sensor and a database;
an estimation module configured to estimate, for each operational criterion, a value of the operational criterion on the basis of each determined value of a characteristic variable associated with said operational criterion and via the implementation of an artificial intelligence algorithm;
a calculation module configured to calculate a deviation between the estimated value of the operational criterion and a desired value of said operational criterion, and of a characteristic variable, known as the causal variable, which is the main cause of said deviation, said causal variable being calculated using the artificial intelligence algorithm;
a performance module configured, if the calculated deviation is greater than a predefined threshold, to perform at least one action selected from the group consisting of: displaying, on a display system, the estimated value of the operational criterion, the calculated deviation and an indication of the causal variable; issuing an alert as a function of the calculated deviation; and generating an instruction to control an avionics system as a function of the estimated value of the operational criterion and the calculated deviation.

The invention further relates to an aircraft comprising an electronic device for assisting in the piloting of an aircraft, the piloting assistance device being as defined above.

### BRIEF DESCRIPTION OF THE DRAWINGS

These features and advantages of the invention will appear more clearly upon reading the following description, given solely as a non-limiting example, and made in reference to the attached drawings, in which:

FIG. 1 is a schematic representation of an aircraft comprising an electronic piloting assistance device according to the invention, connected to avionics systems, to one or more sensors, to a database and to a display system;

FIG. 2 is a schematic representation of a fuzzy logic decision tree included in an artificial intelligence algorithm, implemented by the piloting assistance device of FIG. 1 to estimate the value of an operational criterion on the basis of the value of each variable of a set of characteristic variable(s) associated with said operational criterion, the piloting assistance device then making it possible to monitor at least one operational criterion of an aircraft mission; and

FIG. 3 is a flow chart of a piloting assistance method according to the invention, the method being implemented by the piloting assistance device of FIG. 1.

### DETAILED DESCRIPTION OF EMBODIMENTS

In the description, the phrase “substantially equal to” means being equal within 10%, and preferably within 5%.

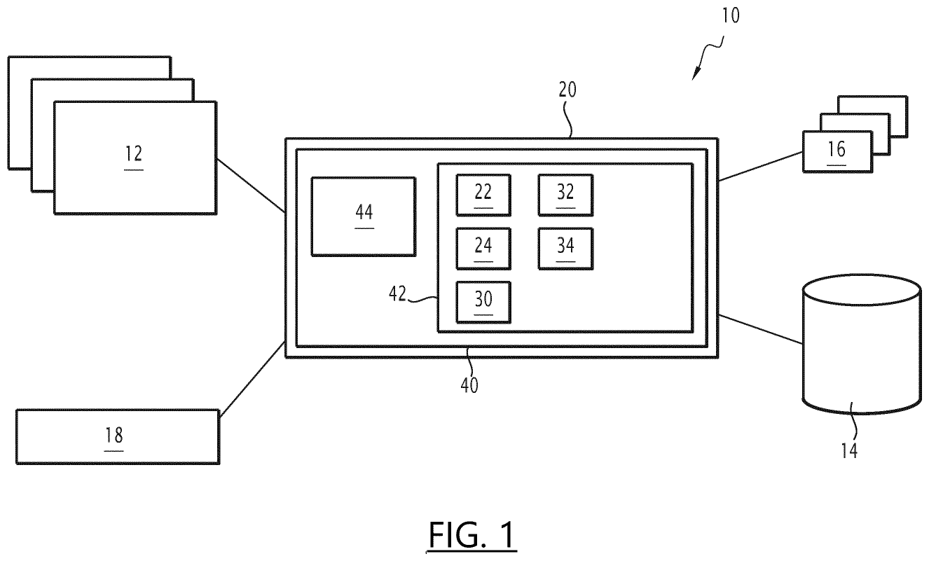

In FIG. 1, an aircraft 10 comprises a plurality of avionics systems 12, one or more databases 14, a plurality of sensors 16, one or more display systems 18, and an electronic piloting assistance device 20 connected to the avionics systems 12, the database(s) 14, the sensors 16 and the display system(s) 18.

The aircraft 10 is, for example, an aeroplane, such as a commercial airliner. Alternatively, the aircraft 10 is a helicopter, or a drone that can be flown remotely by a pilot, or an unmanned autonomous aircraft. A person skilled in the art will note that if the aircraft 10 is an unmanned autonomous aircraft, it preferably does not comprise a display system.

Each avionics system 12 is carried on board the aircraft 10, is known per se, and is configured to implement one or more respective avionics functions.

Each avionics system 12 is capable of transmitting various avionics data to the electronic piloting assistance device 20, for example so-called “aircraft” data, such as the position, speed, acceleration, orientation, heading or altitude of the aircraft 10, and/or so-called “navigation” data, such as a flight plan, an estimated time of arrival, or a number of passengers.

Each avionics system 12 is chosen, for example, from the group consisting of: a flight management system (FMS); a flight guidance system (FG); a flight control system (FCS); a satellite positioning system, such as a global positioning system (GPS); an inertial reference system (IRS), an instrument landing system (ILS) or microwave landing system (MLS); a runway overrun prevention system (ROPS); and a radio altimeter (RA).

Optionally, certain avionics systems 12 can also receive instructions or commands from the electronic piloting assistance device 20. These avionics systems 12 capable of receiving instructions are, for example:
the flight control system, also known as FCS or FBW (Fly-By-Wire), to operate a set of control surfaces and aircraft actuators. In the case of a fixed-wing aircraft, the control surfaces are, for example, ailerons, elevator or rudder. In the case of a rotary-wing aircraft, the control surfaces are, for example, the collective pitch, the cyclic pitch or the tail rotor pitch;
an engine control unit (ECU) for varying the energy delivered by an aircraft engine, such as a jet engine, turboprop, or turbine;
at least one guidance system, such as an autopilot device, also known as an auto-flight control system (AFCS), also known as an autopilot and denoted AP, or such as the aircraft's flight management system (FMS).

Each database 14 is optional, known per se, and is for example chosen from the group consisting of:
a navigation database (NAVDB), containing in particular data relating to prohibited areas or flight zones, data relating to no-fly zones or spaces, data relating to landing strips on which the aircraft 10 is likely to land, this data typically being the position of a threshold of the landing runway, the orientation of the landing runway, the length of the runway, an altitude or a decision point, and so on;
a terrain elevation database, containing information about the height and altitude of the earth's surface;
a performance database, also known as PERFDB (PERFormance Data Base), containing information about the performance of aircraft 10, such as speed, fuel consumption, altitude, range, etc. ;
a maintenance database, containing information on repairs, upkeep, and inspections carried out on the aircraft;
a passenger database, containing information on passengers, such as their names, ages, nationalities, passport numbers, etc. ; and
a meteorological database, containing information on weather conditions such as temperature, pressure, wind speed and direction, visibility, etc. This data is used for flight planning and passenger safety.

These databases are typically interconnected, and populated at least in part by the sensors 16.

In the example shown in FIG. 1, the databases 14 are external to the electronic piloting assistance device 20. Alternatively, not shown, the databases 14 are at least partly internal to the electronic piloting assistance device 20.

The sensors 16 are capable of measuring various quantities associated with the aircraft 10 and/or the environment of the aircraft 10, and include, for example, at least one sensor from: a laser remote sensing device, better known as a lidar (light detection and ranging); a radar (radio detection and ranging); a laser (light amplification by stimulated emission); a telemeter; a radio altimeter; an accelerometer; an inertial measurement unit, also known as an IMU; a Doppler-effect sensor; a satellite positioning sensor, such as a global positioning system (GPS) sensor, a Galileo sensor or a Glonass sensor; one or more stereoscopic cameras; and an atmospheric data sensor, such as for pressure and temperature data.

Each electronic sensor 16 is known per se, and the data measured by each sensor 16 is intended to be acquired by the electronic piloting assistance device 20, to which it is connected.

The display system or systems 18 are, for example, a head-down display system and/or a head-up display system, also known as a HUD. The head-down display system is, for example, a navigation display system. Alternatively or additionally, the display system 18 is a remote display system, in particular a display system external to the aircraft 10, such as a display system in a ground station, or the remote control or vision goggles of a drone operator.

The electronic piloting assistance device 20 is designed to be taken on board the aircraft 10, when the aircraft 10 is an aeroplane or helicopter. Alternatively, the electronic piloting assistance device 20 is intended to be installed on the ground, while being connected to the avionics systems 12 on board the aircraft 10, when the aircraft 10 is a drone that can be piloted remotely by a pilot or an autonomous aircraft without an operator.

The electronic piloting assistance device 20 is designed to provide assistance to the pilot of the aircraft 10, via the monitoring of at least one operational criterion of a mission of the aircraft 10 during the execution of said mission, which then makes it possible to reduce the cognitive load for the pilot. This monitoring is preferably carried out regularly, by regularly estimating a new value for each operational criterion monitored. Each operational criterion is, for instance, chosen from the group consisting of: safety, punctuality, comfort, and ecology.

In addition, the electronic piloting assistance device 20 is configured to monitor several operational criteria, in particular several of the above-mentioned operational criteria, and for example all of the operational criteria from the group consisting of: safety, punctuality, comfort and ecology. According to this addition, the electronic piloting assistance device 20 is preferably configured to monitor a plurality of operational criteria simultaneously. In other words, the plurality of operational criteria are monitored simultaneously, with said operational criteria being monitored in parallel with one another.

In the example shown in FIG. 1, the electronic piloting assistance device 20 is an autonomous electronic device, external to the avionics systems 12, the database(s) 14, the sensors 16 and the display system(s) 18. In other words, in this example, the pilot assistance device 20 is separate and distinct from each of the avionics systems 12. In a variant not shown, the electronic piloting assistance device 20 is integrated into one of the avionics systems 12, i.e. included in one of the avionics systems 12, such as the flight management system or FMS.

The electronic piloting assistance device 20 comprises a module 22 for determining, for each operational criterion, a value of each characteristic variable K₁, K₂, K₃, K₄, K₅ of a set of characteristic variable(s) associated with said operational criterion. The determination module 22 is connected to at least one of the avionics systems 12, the databases 14 and the sensors 16 to acquire the information and/or measured values required to determine each characteristic variable value K₁, K₂, K₃, K₄, K₅.

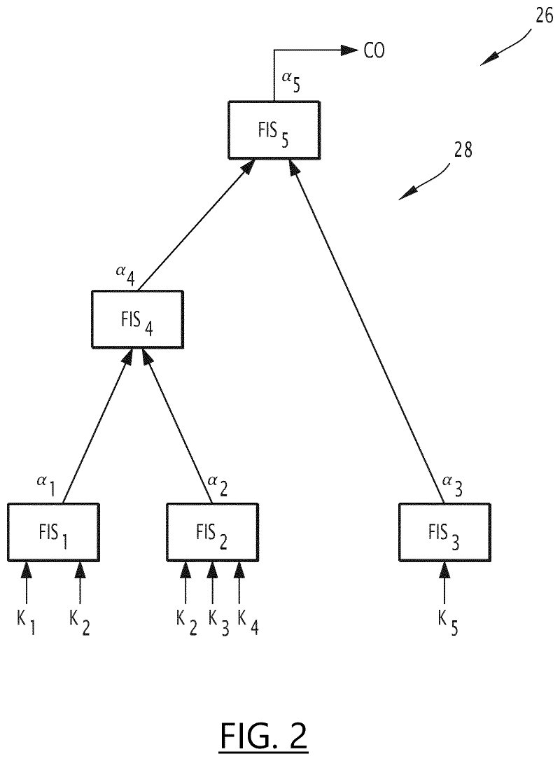

The electronic piloting assistance device 20 also comprises a module 24 for estimating a value of each operational criterion, on the basis of each defined value of characteristic variable K₁, K₂, K₃, K₄, K₅ associated with said operational criterion and via the implementation of an artificial intelligence algorithm 26. The artificial intelligence algorithm 26 comprises, for example, a fuzzy logic decision tree 28, as shown in FIG. 2. The estimation module 24 is connected to the output of the determination module 22.

The electronic piloting assistance device 20 further comprises a module 30 for calculating a difference between the estimated value of the operational criterion and a desired value of said operational criterion, and a characteristic variable, known as the causal variable, which is the main cause of said difference. The calculation module 30 is connected to the output of the estimation module 24.

The electronic piloting assistance device 20 comprises a module 32 for carrying out, if the calculated deviation is greater than a predefined threshold, at least one action from among displaying the estimated value of the operational criterion, the calculated deviation, and an indication of the causal variable; issuing an alert as a function of the calculated deviation; and generating an instruction to control an avionics system as a function of the estimated value of the operational criterion and the calculated deviation. The performance module 32 is connected to the output of the calculation module 30.

Advantageously, the electronic piloting assistance device 20 is configured to regularly, for example periodically, launch the implementation of the determination 22, estimation 24 and calculation 30 modules, in order to regularly estimate a new value for each monitored operational criterion CO, and to regularly calculate a new deviation between the new estimated value and the desired value for each monitored operational criterion CO.

When this implementation of the determination 22, estimation 24 and calculation 30 modules is repeated periodically, the period between two successive iterations of the implementation of the determination 22, estimation 24 and calculation 30 modules is typically less than 10 seconds, preferably less than 5 seconds, and even more preferably less than 1 second.

As an optional addition, the electronic piloting assistance device 20 further comprises a module 34 for detecting at least one of a change in an environment of the aircraft 10, a change in the desired value of a respective operational criterion CO and/or an action by the pilot that is different from a planned action. According to this optional addition, the detection module 34 is then configured so as to, in the event of detection of the at least one change, re-launch the implementation of the determination 22, estimation 24 and calculation 30 modules in order to estimate a new value for each operational criterion CO monitored and to calculate a new deviation, for each operational criterion CO monitored, between the new estimated value and the desired value of said operational criterion CO.

In the example shown in FIG. 1, the electronic piloting assistance device 20 comprises an information processing unit 40 formed for example by a memory 42 and a processor 44 associated with the memory 42.

In the example shown in FIG. 1, the determination module 22, estimation module 24, calculation module 30 and performance module 32, and in the case of the optional addition the detection module 34, are each in the form of software, or a software brick, which can be executed by the processor 44. The memory 42 of the electronic piloting assistance device 20 is then able to store software for determining, for each operational criterion, a value of each characteristic variable; software for estimating a value for each operational criterion; software for calculating the causal variable and the deviation between the estimated and desired values of the operational criterion; and software for performing at least one of the following actions: displaying the estimated value of the operational criterion, the calculated deviation and the indication of the causal variable, issuing the alert as a function of the calculated deviation and generating the control instruction to the avionics system. As an optional addition, the memory 42 of the electronic piloting assistance device 20 is then able to store software for detecting the at least one change. The processor 44 is then able to execute each one of the determination software, estimation software, calculation software, and performance software, and in the case of the optional addition the detection software.

When, as an alternative, not shown, the database 14 is an internal database of the electronic piloting assistance device 20, it is typically able to be stored in a memory of the electronic piloting assistance device 20, such as the memory 42.

In a variant not shown, the determination module 22, the estimation module 24, the calculation module 30 and the performance module 32, and in the optional addition the detection module 34, are each in the form of a programmable logical component, such as an FPGA (field-programmable gate array), or as a dedicated integrated circuit, such as an ASIC (application-specific integrated circuit).

When the electronic piloting assistance device 20 is in the form of one or more software, that is to say in the form of a computer program, it is also capable of being stored on a computer-readable medium, not shown. The computer-readable medium is, for example, a medium that can store electronic instructions and be coupled with a bus from a computer system. For example, the readable medium is an optical disk, magneto-optical disk, ROM memory, RAM memory, any type of non-volatile memory (for example EPROM, EEPROM, FLASH, NVRAM), magnetic card or optical card. The readable medium in such a case stores a computer program comprising software instructions.

The determination module 22 is configured to determine, for each operational criterion CO, a value of each characteristic variable K₁, K₂, K₃, K₄, K₅ of a set of characteristic variables associated with said operational criterion CO. The set of characteristic quantities is specific to each operational criterion CO and predefined for each operational criterion CO.

Advantageously, for each operational criterion CO, the set of characteristic variable(s) associated with said operational criterion CO and/or the desired value of said operational criterion CO can be consulted and modified by a user.

The set of characteristic variable(s) K₁, K₂, K₃, K₄, K₅ associated with safety comprises, for example, a lift of the aircraft 10, a ratio between the amount of fuel available and the amount of fuel required, and an indicator quantifying the aircraft's 10 adherence to a flight plan.

The set of characteristic variable(s) K₁, K₂, K₃, K₄, K₅ associated with punctuality typically comprises an indicator quantifying an arrival delay of the aircraft 10, a ratio between a number of passengers who missed a connection on arrival and a total number of passengers of the delayed flight, an indicator quantifying a delay of a subsequent flight of the aircraft 10 due to the delay of the current flight of the aircraft 10.

The set of characteristic variable(s) K₁, K₂, K₃, K₄, K₅ associated with comfort comprises, for example, a take-off delay indicator, a number of vertical accelerations above a predefined threshold during the flight and a cumulative duration of vertical accelerations above a predefined threshold during the flight.

The set of characteristic variable(s) K₁, K₂, K₃, K₄, K₅ associated with ecology typically comprises a quantity of carbon dioxide emitted during flight, an indicator of the use of favourable air currents to modify the path of the aircraft 10 relative to a path initially planned, a level of noise generated on the ground during landing, a ratio between a quantity of carbon dioxide emitted during the flight and a number of passengers carried.

Each characteristic variable K₁, K₂, K₃, K₄, K₅ is determined from at least one avionics variable, each avionics variable being acquired from a source chosen from the avionics systems 12, the database(s) 14 and the sensors 16. The determination of each characteristic variable K₁, K₂, K₃, K₄, K₅ from at least one avionics variable is known per se.

The estimation module 24 is configured to estimate, for each operational criterion CO, a value of the operational criterion CO on the basis of each determined value of characteristic variable K₁, K₂, K₃, K₄, K₅ associated with said operational criterion CO and via the implementation of the artificial intelligence algorithm 26, and for example the fuzzy logic decision tree 28.

The fuzzy logic decision tree 28, also known as the GFT (Generalized Fuzzy Tree), can also be used to make decisions with uncertain or imprecise data. Unlike traditional decision trees that use binary rules to make decisions (true/false), the fuzzy logic decision tree 28 uses linguistic variables to represent concepts such as “very likely” or “somewhat likely”.

The fuzzy logic decision tree 28 operates by evaluating the input variables, namely the determined value(s) of characteristic variable(s) K₁, K₂, K₃, K₄, K₅ associated with the respective operational criterion CO, these input variables being quantitative or qualitative data, and then by converting them into degree of match values for the corresponding linguistic variables. For example, if the input variable is the indicator quantifying compliance with the flight plan or, for example, the take-off delay indicator, the value of this variable is translated into the degree to which it matches linguistic variables, such as “low”, “medium” or “high”.

The fuzzy logic decision tree 28 then uses fuzzy rules to evaluate these degrees of matching and make decisions. These rules are generally defined by experts in the field or by historical data. Fuzzy rules are typically represented as “if . . . then” with linguistic variables.

As an optional addition, the fuzzy logic decision tree 28 uses inference methods to calculate the final output by combining the results of several rules. An example of such an inference method is the Mamdani method, which uses the weighted average of the rules to calculate the output.

The fuzzy logic decision tree 28 can then be used to estimate the value of the corresponding operational criterion CO in uncertain or imprecise environments using linguistic concepts and fuzzy rules, rather than rigid binary rules.

Advantageously, the fuzzy logic decision tree 28 includes at least one fuzzy inference system (FIS) FIS₁, FIS₂, FIS₃, FIS₄, FIS₅, each fuzzy inference system FIS₁, FIS₂, FIS₃, FIS₄, FIS₅ being configured to receive as input at least one given value of characteristic variable K₁, K₂, K₃, K₄, K₅ and to deliver as output a unitary evaluation value; for each fuzzy inference system FIS₁, FIS₂, FIS₃, FIS₄, FIS₅, a correspondence between input(s) and output being established by fuzzy logic; the value of the operational criterion CO then being estimated on the basis of the unit evaluation value(s) calculated for the set of characteristic variable(s) associated with said CO operational criterion.

In the example shown in FIG. 2, the fuzzy logic decision tree 28 is then represented as a graph of fuzzy inference systems FIS₁, FIS₂, FIS₃, FIS₄, FIS₅, each with an associated weighting coefficient α₁, α₂, α₃, α₄, α₅. In this example, the fuzzy logic decision tree 28 comprises five fuzzy inference systems FIS₁, FIS₂, FIS₃, FIS₄, FIS₅, namely a first fuzzy inference system FIS₁ with a first weighting coefficient α₁, a second fuzzy inference system FIS₂ with a second weighting coefficient α₂, a third fuzzy inference system FIS₃ with a third weighting coefficient α₃, a fourth fuzzy inference system FIS₄ with a fourth weighting coefficient α₄ and a fifth fuzzy inference system FIS, with a weighting coefficient α₅.

In this example, the fuzzy inference systems are distributed over three levels, namely a lower level corresponding to the first, second and third fuzzy inference systems FIS₁, FIS₂, FIS₃ receiving the input variables, i.e. the determined values of the set of characteristic variable(s) K₁, K₂, K₃, K₄, K₅ associated with the corresponding operational criterion CO; an intermediate level corresponding to the fourth fuzzy inference system FIS₄ connected to the output of the first and second fuzzy inference systems FIS₁, FIS₂; and an upper level corresponding to the fifth fuzzy inference system FIS, connected to the output of the third and fourth fuzzy inference systems FIS₃, FIS₄, the fifth fuzzy inference system FIS, then being configured in this example to deliver at its output the estimated value of the operational criterion CO.

Each fuzzy inference system FIS₁, FIS₂, FIS₃, FIS₄, FIS₅ is a structure for formalising the fuzzy rules that govern the decision-making of the decision tree 28. Each fuzzy inference system FIS₁, FIS₂, FIS₃, FIS₄, FIS, comprises, for example, one or more input variables, each typically divided into a certain number of linguistic categories, called “fuzzy sets”; one or more matching functions, i.e. mathematical functions assigning a degree of match value to each input for each fuzzy set; one or more fuzzy rules governing decision-making, typically of the form “If the input is in fuzzy set A AND the input is in fuzzy set B, then the output is in fuzzy set C”; one or more inference functions combining the degrees of match of the input fuzzy sets to determine the degrees of match of the output fuzzy sets; one or more output variables representing the final decision, each typically divided into a number of fuzzy sets, in a similar way to the input variables; and one or more aggregation functions combining the degrees of match of the output fuzzy sets to determine the final output value. The aggregation function is, for example, a weighted sum.

The fuzzy logic decision tree 28 has previously been trained in a preliminary learning step of the artificial intelligence algorithm 26 based on training data.

Advantageously, the preliminary learning of the artificial intelligence algorithm 26 is supervised learning. The person skilled in the art will note that supervised learning is not direct. The operator annotates a result while the artificial intelligence algorithm 26, in particular the fuzzy logic decision tree 28, takes characteristic variables as input. To build the learning base, it is therefore necessary to provide a set of contextualised results; then, for each result in this set, to evaluate the characteristic quantities; and finally, for each result in this set, to have it annotated by a user in operational semantics.

The supervised learning of the fuzzy logic decision tree 28 begins with the collection of input and output training data. The input data are typically characteristics or attributes that describe a situation or problem, while the output data represent the expected results for each situation or problem. The logic rules of the fuzzy logic decision tree 28 are then constructed from the training data.

The preliminary learning of the fuzzy logic decision tree 28 is preferably carried out using a genetic algorithm. For said genetic algorithm learning, a set of individuals is created, each individual representing a potential fuzzy logic decision tree. Each decision tree is evaluated on the basis of its decision-making accuracy, which is measured using a fitness function. Individuals with a higher fitness function are selected to reproduce and create offspring. Reproduction involves combining the characteristics of the parents, while adding a certain amount of variation to encourage the exploration of new solutions. The offspring created are then subjected to an fitness function evaluation to determine whether they are better or worse than their parents. The best individuals are kept for the next generation, while the worst performers are eliminated. This process is repeated over several generations until a satisfactory fuzzy logic decision tree is found. Once the genetic algorithm has converged on a solution, the trained fuzzy logic decision tree 28 is used to make decisions based on new input data. The fitness function calculates, for example, the average of the deviations between the output of the model under training and an operational semantic annotation, typically at a high level. This fitness function must be minimised during the learning process.

The calculation module 30 is configured to calculate a deviation between the estimated value of the operational criterion CO and a desired value of said operational criterion CO, and a characteristic variable, known as the causal variable, which is the main cause of said deviation.

The calculated deviation is, for example, the difference between the desired value and the estimated value of the operational criterion CO, the calculated deviation being a relative number. Alternatively, the calculated deviation is the difference in absolute value between the estimated value and the desired value of the operational criterion CO, and the calculated deviation is then a positive number.

The causal variable is calculated via the fuzzy logic decision tree 28, taking into account the weighting coefficient α₁, α₂, α₃, α₄, as associated respectively with each fuzzy inference system FIS₁, FIS₂, FIS₃, FIS₄, FIS₅.

The performance module 32 is configured, if the calculated deviation is greater than a predefined threshold, to perform at least one action selected from the group consisting of: displaying, on a display system 18, the estimated value of the operational criterion CO, the calculated deviation and an indication of the causal variable; issuing an alert as a function of the calculated deviation; and generating an instruction to control an avionics system 12 as a function of the estimated value of the operational criterion CO and the calculated deviation.

As an optional addition, the performance module 32 is configured to display the estimated value of the operational criterion and the calculated deviation regardless of the value of the calculated deviation, in particular also if the calculated deviation is less than or equal to the predefined threshold.

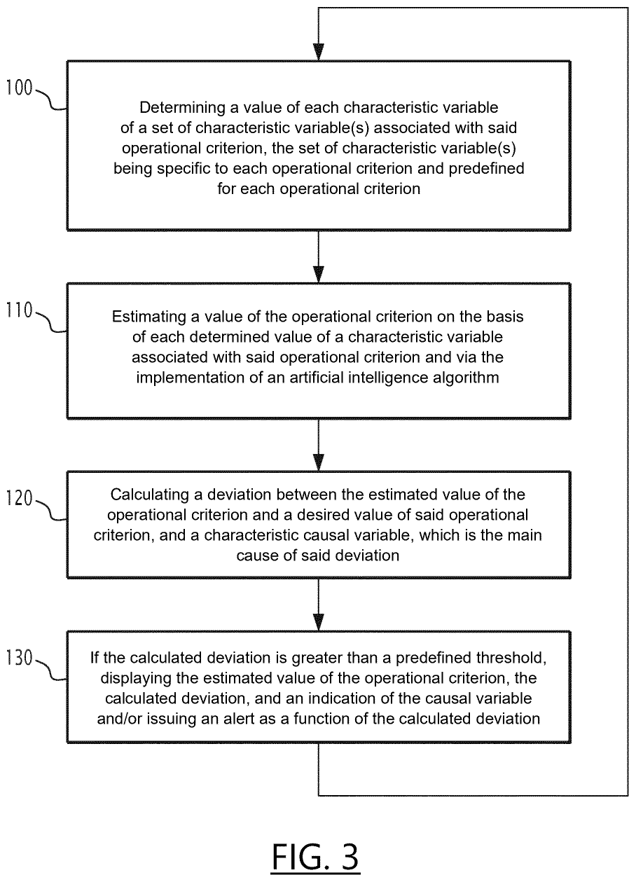

The operation of the electronic piloting assistance device 20 will now be described with reference to FIG. 3, which shows a flow chart of the piloting assistance method according to the invention, implemented by the electronic piloting assistance device 20.

In a preliminary learning step, not shown, the artificial intelligence algorithm 26 is trained on the basis of the learning data, preferably in a supervised manner, and even more preferably by using a genetic algorithm, as described above.

After this preliminary training of the artificial intelligence algorithm 26, during an initial step 100, the electronic piloting assistance device 20 determines, via its determination module 22 and for each operational criterion CO, the value of each characteristic variable K₁, K₂, K₃, K₄, K₅ of the set of characteristic variables associated with said operational criterion CO. Each characteristic variable K₁, K₂, K₃, K₄, K₅ is then determined in a manner known per se from at least one avionics variable, each one being acquired from a source chosen from the avionics systems 12, the database(s) 14 and the sensors 16.

At the end of the determination step 100, the piloting assistance device 20 goes on to the next step 110 during which it estimates, via its estimation module 24 implementing the artificial intelligence algorithm 26, the value of the operational criterion CO from each determined value of a characteristic variable K₁, K₂, K₃, K₄, K₅ associated with said operational criterion CO. More specifically, this estimation is carried out using the fuzzy logic decision tree 28, as described above.

After the estimation step 110, the piloting assistance device 20 calculates, in the next step 120 and via its calculation module 30, the deviation, such as a relative difference or difference in absolute value, between the estimated and desired values of the operational criterion CO.

At the end of the calculation step 120, if the calculated deviation is greater than the predefined threshold, the piloting assistance device 20, in the next step 130 and via its performance module 32, displays the relevant information on the display system 18, in particular the estimated value of the operational criterion CO, the calculated deviation and the indication of any causal variable; and/or issues the alert as a function of the calculated deviation; or generates the control instruction for the corresponding avionics system 12 as a function of the estimated value of the operational criterion CO and the calculated deviation.

The person skilled in the art will note that, as an optional addition, the estimated value of the operational criterion and the calculated deviation are displayed on the display system 18 during the performance step 130 regardless of the value of the calculated deviation, and in particular also if the calculated deviation is less than or equal to the predefined threshold.

Advantageously, as an optional addition, a trend indicator is also displayed in order to indicate to the operator in what direction the estimated value of the operational criterion CO has moved, compared with a previous estimated value of said operational criterion CO.

The steps of determining 100, estimating 110, and calculating 120 are repeated regularly, and for example periodically, so that at the end of the calculation step 120 20 or performance step 130, the piloting assistance device returns to the initial determination step 100 in order to estimate a new value for each monitored operational criterion CO.

In addition or alternatively, the steps of determining 100, estimating 110, and calculating 120 are implemented again, i.e. reiterated, following the detection, during a complementary detection step, not shown, of at least one evolution among the modification of the environment of the aircraft 10, the change of the desired value of the respective operational criterion CO and an action of the pilot different from the planned one.

The change in the environment of the aircraft 10 is, for example, a change in the meteorological environment, or the receipt of a NOTAM (NOTice to AirMen) message, i.e. a message to aviators, generally published by government air traffic control agencies with the aim of informing pilots of infrastructure changes.

Thus, the piloting assistance device 20 according to the invention offers significant assistance to the user, such as the pilot of the aircraft 10, by enabling them to more effectively assess the chances of success of the mission of the aircraft 10 or the need to replan it, by estimating the value of each operational criterion CO associated with the mission, and then by displaying the estimated value and variations in each operational criterion CO. This reduction in the cognitive load for the user then helps to improve the flight safety of the aircraft 10.

By regularly, preferably periodically, calculating the deviation between the estimated and desired values of the operational criterion CO, the piloting assistance device 20 also performs the role of a guardian angel for piloting the aircraft 10, typically by drawing the user's attention in the form of a visual and/or audible alert if the calculated deviation is greater than the predefined threshold.

The piloting assistance device 20 can also provide the user with an indication of the causal variable that is the main cause of this deviation. This makes it easier to explain to the user the cause of the reported deviation, thereby further reducing the cognitive load, particularly in order to know how to react in order to limit that deviation. The fuzzy logic decision tree 28 then makes the diagnosis more intelligible to the user.

In addition, the piloting assistance device 20 helps the pilot to look for symptoms of a situation by monitoring a plurality of operational criteria at the same time, estimated in parallel with each other, such as safety, punctuality, comfort and ecology. This multi-criteria monitoring is then even more relevant and useful for the user, enabling them to further reduce their cognitive load.

In addition, the pilot assistance device 20 is capable of taking into account the consequences of a change in the context, such as a change in the aircraft environment, a change in the pilot's intention for at least one operational criterion, and an action by the pilot that differs from a planned action. The pilot assistance device 20 thus enables the user to better assess the impact of this change in the context in relation to the desired value of each operational criterion CO, i.e. the initially defined performance of the aircraft 10 during its mission.

1. A method for assisting piloting of an aircraft by monitoring at least one operational criterion of a mission of the aircraft during execution of the mission, the method being implemented by an electronic assistance device and comprising, for each operational criterion criterion:
determining a value of each characteristic variable of a set of characteristic variable(s) associated with the operational criterion, the set of characteristic variable(s) being specific to each operational criterion and predefined for each operational criterion), each characteristic variable being determined from at least one avionics variable, each avionics variable being acquired from a source selected from an avionics system, a sensor and a database;
estimating a value of the operational criterion on the basis of based on each determined value of a characteristic variable associated with the operational criterion and by implementing an artificial intelligence algorithm;
calculating a deviation between the estimated value of the operational criterion and a desired value of the operational criterion, and of a characteristic variable, known as the causal variable, which is a main cause of the deviation, the causal variable being calculated using the artificial intelligence algorithm; and
if the calculated deviation is greater than a predefined threshold, displaying, on a display system, the estimated value of the operational criterion, the calculated deviation and an indication of the causal variable, and performing at least one action selected from the group consisting of issuing an alert as a function of the calculated; deviation, and generating an instruction to control an avionics system as a function of the estimated value of the operational criterion.

2. The method according claim 1, further comprising detecting at least one change from the group consisting of: a change in an environment of the aircraft, a change in the desired value of a respective operational criterion, and an action by the pilot that differs from a planned action, wherein said determining, said estimating and said calculating are implemented again following this detection and as a function of the at least one change detected.

3. The method according to any one of the claim 1, wherein said determining, said estimating and said calculating are repeated regularly.

4. The method according to claim 1, wherein for each operational criterion, the set of characteristic variable(s) associated with the operational criterion is consulted and modified by a user.

5. The method according to claim 1, wherein a plurality of operational criteria are monitored.

6. The method according to claim 1, wherein each operational criterion is selected from the group consisting of: safety, punctuality, comfort, and ecology.

7. (canceled)

8. The method according to claim 1, wherein the artificial intelligence algorithm comprises a fuzzy logic decision tree.

9. The method according to claim 1, further comprising preliminarily learning comprising training the artificial intelligence algorithm based on training data.

10. A non-transitory computer readable memory storing a computer program which, when executed by a computer, causes the computer to perform a method according to claim 1.

11. Electronic device for assisting in piloting of an aircraft via monitoring of at least one operational criterion of a mission of the aircraft during execution of the mission, the device comprising:
a determination module configured to determine a determiner determining, for each operational criterion, a value of each characteristic variable of a set of characteristic variable(s) associated with the operational criterion, the set of characteristic variable(s) being specific to each operational criterion and predefined for each operational criterion, each characteristic variable being determined from at least one avionics variable, each avionics variable being acquired from a source selected from an avionics system, a sensor, and a database;
an estimator estimating, for each operational criterion, a value of the operational criterion based on each determined value of a characteristic variable associated with the operational criterion and by an artificial intelligence algorithm;
a calculator calculating a deviation between the estimated value of the operational criterion and a desired value of the operational criterion, and of a characteristic variable, known as the causal variable, which is a main cause of the deviation, the causal variable being calculated using the artificial intelligence algorithm;
a performer that, when the calculated deviation is greater than a predefined threshold, displays, on a display system, the estimated value of the operational criterion, the calculated deviation and an indication of the causal variable, and performs at least one action selected from the group consisting of issuing an alert as a function of the calculated deviation, and generating an instruction to control an avionics system as a function of the estimated value of the operational criterion and the calculated deviation the at least one action performed.

12. An aircraft comprising an electronic device for according to claim 11, assisting in the piloting of an aircraft.

13. The method according to claim 1, wherein for each operational criterion, the desired value of the operational criterion is consulted and modified by a user.

14. The method according to claim 1, wherein said determining, said estimating and said calculating are repeated periodically.

15. The method according to claim 14, wherein the period between two successive iterations of said determining, said estimating and said calculating is less than 10 seconds.

16. The method according to claim 5, wherein the operational criteria are monitored simultaneously.

17. The method according to claim 1, wherein if a plurality of operational criteria are monitored, the operational criteria are all the group's operational criteria consisting of: safety, punctuality, comfort and ecology.

18. The method according to claim 17, wherein (i) the set of characteristic variable(s) associated with safety comprises: a lift of the aircraft, a ratio between the amount of fuel available and the amount of fuel required, and an indicator quantifying the aircraft's adherence to a flight plan, wherein (ii) the set of characteristic variable(s) associated with punctuality comprises: an indicator quantifying an arrival delay of the aircraft, a ratio between a number of passengers who missed a connection on arrival and a total number of passengers of the delayed flight, and an indicator quantifying a delay of a subsequent flight of the aircraft due to the delay of the current flight of the aircraft, wherein (iii) the set of characteristic variable(s) associated with comfort comprises: a take-off delay indicator, a number of vertical accelerations above a predefined threshold during the flight, and a cumulative duration of vertical accelerations above a predefined threshold during the flight, and wherein (iv) the set of characteristic variable(s) associated with ecology comprises: a quantity of carbon dioxide emitted during flight, an indicator of the use of favorable air currents to modify the path of the aircraft relative to a path initially planned, a level of noise generated on the ground during landing, and a ratio between a quantity of carbon dioxide emitted during the flight and a number of passengers carried.

19. The method according to claim 8, wherein the fuzzy logic decision tree comprises at least one fuzzy inference system, each fuzzy inference system receiving as input at least one given value of characteristic variable and delivering as output a unitary evaluation value, wherein for each fuzzy inference system, a correspondence between input(s) and output is established by fuzzy logic, and wherein the value of the operational criterion is then estimated on the basis of the unitary evaluation value(s) calculated for the set of characteristic variable(s) associated with the operational criterion.

20. The method according to claim 9, wherein said preliminarily learning comprises supervised learning.

21. The method according to claim 20, wherein if the artificial intelligence algorithm comprises a fuzzy logic decision tree, said preliminarily learning comprises learning the fuzzy logic decision tree by performing a genetic algorithm.
